(19) United States
(12) Patent Application Publication
(10) Pub. No.: US 2007/0168721 A1
(43) Pub. Date: Jul. 19, 2007

(54) Method, network entity, system, electronic device and computer program product for backup and restore provisioning

(75) Inventors: Vesa Luiro, Kempele (FI); Jouni Kangas, Vantaa (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 11/315,734

(22) Filed: Dec. 22, 2005

(51) Int. Cl. G06F 11/00

(52) U.S. Cl. 714/15

(57) ABSTRACT

A method, network entity, system, electronic device and computer program product for backing up and restoring data are provided. More specifically, a means for distributing responsibility for providing backup and restore services to multiple service providers is provided. In particular, in lieu of storing actual backup data (i.e., copies of all data stored on an electronic device) to one or more servers used exclusively for storing backup data, one or more provisioning files, which describe the data and where and how it can be found (e.g., the original source of the data), may alternatively be created and stored on the Backup and Restore Server. When it becomes necessary to restore previously installed data to the device, the Backup and Restore Server may access the provisioning file(s) and use it to fetch and install the data.

### FIELD OF THE INVENTION

Exemplary embodiments of the present invention relate generally to the process of backing up and restoring data and, more particularly, to distributing responsibility for the backup and restore process.

### BACKGROUND OF THE INVENTION

The process of backing up data, such as software applications, data and media files, and the like, is becoming increasingly important, particularly to businesses that are relying more and more on their electronic devices (e.g., personal computers (PCs), mobile PCs or laptops, personal digital assistants (PDAs), and even mobile phones) for generating, sending and receiving such data. As reliance on these devices increases, the size and importance of the data being stored is likewise increasing rapidly.

Despite the fact that electronic devices are capable of communicating with one another and with various service providers, wirelessly or using wired communications channels, over networks, such as Local Area Networks (LANs), Metropolitan Area Networks (MANs), Wide Area Networks (WANs), Wireless Local Area Networks (WLAN), and the like, using improved communications protocols, such as 2G wireless communication protocols IS-136 (TDMA), Global System for Mobile Communications (GSM), and IS-95 (CDMA), 2.5G wireless communication protocols General Packet Radio Service (GPRS), Enhanced Data GSM Environment (EDGE), and/or 3G wireless communication protocols such as Universal Mobile Telephone System (UMTS) network employing Wideband Code Division Multiple Access (WCDMA) radio access technology and, therefore, are capable of downloading data that has been stored as backup more quickly, there is still an increased cost and time involved in this process, particularly as the size of that data increases.

According to a typical backup and restore process, a user, for example a company or business, will contract with a backup and restore service provider to store a copy of all data installed on, e.g., saved on, the devices operated by the company's employees. The backup and restore service provider will then be responsible for storing a copy of all of the installed data in one or more backup and restore servers used almost exclusively for this purpose. In the event that an employee's electronic device malfunctions and he or she loses all or part of the data stored on the device altogether, or he or she loses the device, the backup and restore service provider will access the data stored on its servers and transfer that data to the employee's device (existing or new) for installation. This process can be costly and time consuming, and it requires that the backup and restore service provider maintain enormous amounts of memory for storing the backup data.

A need, therefore, exists for a backup and restore process that is faster, less expensive and/or requires less memory consumption on the part of the backup and restore service provider.

### BRIEF SUMMARY OF THE INVENTION

In general, exemplary embodiments of the present invention provide an improvement over the known prior art by, among other things, providing a means for distributing responsibility for providing backup and restore services to multiple service providers. In particular, according to exemplary embodiments, in lieu of storing actual backup data (i.e., copies of all data stored on an electronic device) to one or more servers used exclusively for storing backup data, one or more provisioning files, which describe the data and where and how it can be found (e.g., the original source of the data), may alternatively be created and stored on the Backup and Restore Server. When it becomes necessary to restore previously installed data to the device, the Backup and Restore Server may access the provisioning file(s) and use it to fetch and install the data. More specifically, the Backup and Restore Server of exemplary embodiments contacts one or more distributed servers responsible for storing the data and requests the transmission of the data to the electronic device. In other words, the Backup and Restore Server of exemplary embodiments may not install the data itself to the electronic device. Rather, the installation may be handled by one or more distributed servers (e.g., servers associated with the original service providers). The Backup and Restore Server may be responsible for managing the installation process, while the distributed servers act as the downloading servers. The method provided herein may be used for storing all of the backup data required by a particular customer or system. Alternatively, it may be used in conjunction with the Traditional Backup System, wherein some of the actual data remains stored on the Backup and Restore Servers.

In accordance with one aspect of the invention, a method of restoring data is provided. In one exemplary embodiment, the method includes: (1) receiving a request to restore data previously installed on an electronic device associated with a user; (2) accessing a file comprising a description of the data installed on the electronic device; (3) locating, based on the description, one or more sources of the data; and (4) transmitting a signal, which requests transmission of the data described in the file, to at least one source.

In one exemplary embodiment the description includes at least one of a name, location or version associated with the data. In another exemplary embodiment, a matching file also including a description of the data installed on the electronic device is stored on the electronic device itself. This matching file may be capable of being updated when additional data is installed on the electronic device. The method of this embodiment may, therefore, further include synchronizing the file to the matching file, such that the file contains an up to date description of the data following synchronization.

In one exemplary embodiment the method further includes creating the file based on information received from the electronic device regarding data installed on the electronic device, storing the file, creating a matching file also including a description of the data installed on the electronic device, transmitting the matching file to the electronic device, and periodically synchronizing the file to the matching file. As above, the matching file may be capable of being updated when additional data is installed on the electronic device, such that the file includes an up to date description of the installed data following synchronization.

In another exemplary embodiment, the sources may be associated with one or more service providers responsible for providing the data to the electronic device for installation. The sources may further be responsible for updating the data and storing a latest version of the data. In this exemplary embodiment, transmitting a signal to at least one source requesting transmission of the data may include transmitting a signal requesting the latest version of the data.

In one exemplary embodiment, transmitting a signal to at least one source requesting transmission of the data may include transmitting a signal requesting transmission of the data to the electronic device. Alternatively, in another exemplary embodiment, transmitting the signal may include transmitting a signal requesting transmission of the data to a second electronic device associated with the user.

In accordance with another aspect of the invention, a system is provided for backing up and restoring data. In one exemplary embodiment, the system includes: (1) an electronic device associated with a user and capable of storing data; (2) one or more provisioning servers capable of providing the data to the electronic device; and (3) a backup and restore server capable of accessing a file comprising a description of the data installed on the electronic device to determine a location associated with at least one provisioning server responsible for providing the data described in the file, and transmitting a signal, which requests transmission of the data, to the at least one provisioning server.

According to yet another aspect of the invention, a network entity is provided. In one exemplary embodiment, the network entity includes a processor and a memory in communication with the processor that stores an application executable by the processor, wherein the application is capable, upon execution, of: (1) receiving a request to restore data installed on an electronic device associated with a user; (2) accessing a file comprising a description of the data installed on the electronic device; (3) locating, based on the description, one or more provisioning sources that are responsible for storing the data and are associated with one or more original sources of the data; and (4) transmitting a signal, which requests transmission of the data described in the file, to at least one of the provisioning sources.

According to another aspect of the invention, an electronic device is provided for backing up and restoring data. In one exemplary embodiment the electronic device includes a processor and a memory in communication with the processor that stores an application executable by the processor, wherein the application is capable, upon execution, of: (1) creating a first provisioning file comprising a description of data installed on the electronic device; (2) updating the first provisioning file as additional data is installed on the device; and (3) synchronizing the first provisioning file to a second provisioning file stored on a network entity, such that the network entity is capable of using the second provisioning file to provide the data to the electronic device.

In accordance with yet another aspect of the invention a computer program product is provided for restoring data. The computer program product contains at least one computer-readable storage medium having computer-readable program code portions stored therein. The computer-readable program code portions of one exemplary embodiment include: (1) a first executable portion for receiving a request to restore data previously installed on an electronic device associated with a user; (2) a second executable portion for accessing a file comprising a description of the data installed on the electronic device; (3) a third executable portion for locating, based on the description, one or more sources of the data; and (4) a fourth executable portion for transmitting a signal, which requests transmission of the data described in the file, to at least one source.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a block diagram of one type of system that would benefit from exemplary embodiments of the present invention;

FIG. 2 is a schematic block diagram of an entity capable of operating as a backup and restore server and/or provisioning server in accordance with exemplary embodiments of the present invention;

FIG. 3 is a schematic block diagram of a mobile station capable of operating in accordance with an exemplary embodiment of the present invention; and

FIG. 4 is a flow chart illustrating the steps which may be taken in order to backup and restore data in accordance with an exemplary embodiment of the present invention.

### DETAILED DESCRIPTION OF THE INVENTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Overview:

In general, exemplary embodiments of the present invention provide a technique of backing up and restoring data that alleviates some of the burden placed on backup and restore service providers to store copies of all data stored on electronic devices for which they are responsible for providing backup and restore services. In particular, instead of storing actual copies of all of the data stored on respective electronic devices, the backup and restore service provider may store one or more files that merely describe at least some of that data. For example, the file may name the data and provide a location from which the data may be retrieved. In one exemplary embodiment, that location is the location of a server associated with a service provider responsible for originally providing the data to the electronic device for installation. Each file may correspond with a particular installed application, data object, or the like. Alternatively, a single file may provide a description of multiple applications or data objects.

One advantage to using the technique of backup and restore provided by embodiments of the present invention is, therefore, that it eliminates the need for a backup and restore service provider to store all of the backup data to its backup and restore servers. By contrast, the responsibility is shifted to the respective service providers that provided the original data to the device when first installed or accessed. As a result, the time and cost associated with backup is decreased along with the amount of memory consumption required on the server side. Exemplary embodiments of the present invention use the fact that service providers (i.e., the companies that originally provided the installed data) typically maintain and update the applications, or other data, they provide on their servers (referred to herein as “provisioning servers”), to eliminate the requirement that backup and restore service providers similarly store this data to their backup and restore servers. In addition, the reliability of the process may be improved, since no one entity is responsible for storing all of the backup data.

A further byproduct of this technique of backup and restore is the fact that the latest version or release of the data can be restored to the electronic device, rather than the version or release that was originally installed. This is particularly beneficial where it does not become necessary to restore data to the electronic device until months or even years after the data was originally installed or accessed.

Overall System and Relevant Components:

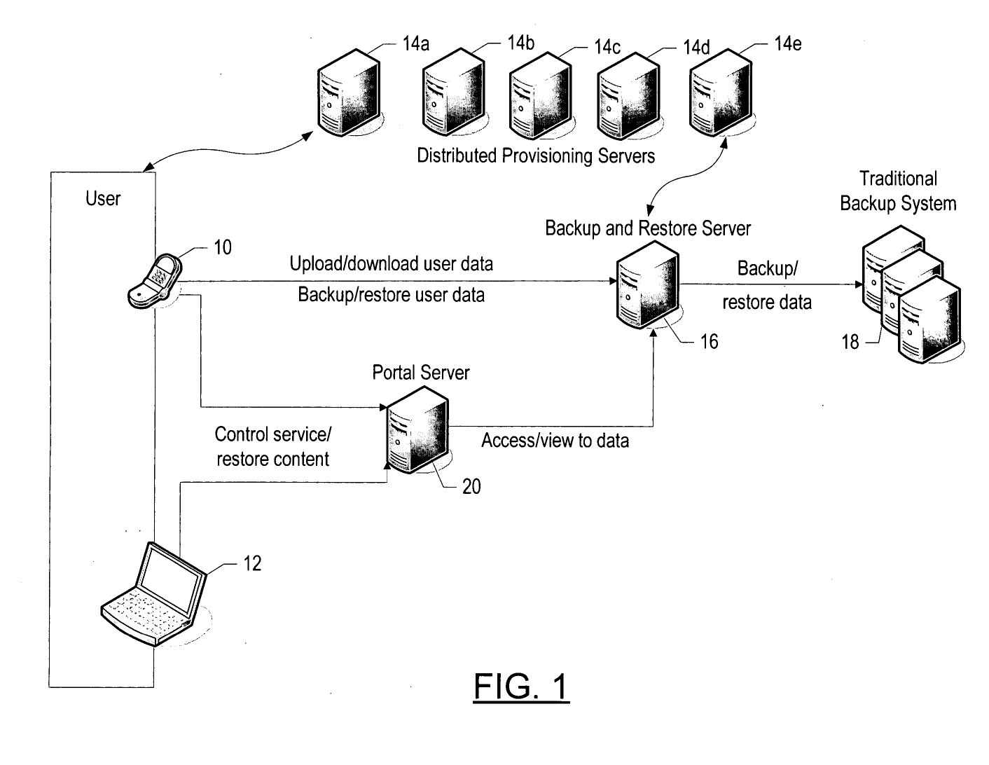

Reference is now made to FIG. 1, which illustrates one type of system in which exemplary embodiments of the present invention may be implemented. As shown, the system may include one or more electronic devices 10, 12, such as cellular telephones, personal digital assistants (PDAs), personal computers (PCs), mobile PCs or laptops, or the like, in communication with a network entity, such as a Backup and Restore Server 16, for the purpose of backing up and restoring data installed on or created by the electronic device. In one exemplary embodiment, the Backup and Restore Server 16 is associated with a Backup and Restore service provider with which the user of the electronic devices has contracted for backup and restore services.

The system may further include one or more provisioning servers 14a-e, or similar network entity also referred to herein as provisioning sources, in communication with both the electronic devices 10, 12 and the Backup and Restore Server 16. In one exemplary embodiment, the provisioning servers 14a-e are associated with corresponding service providers who provide data, such as software applications, games, multimedia, files and the like, to the users over a wired or wireless network. In particular, these provisioning servers, or sources, 14a-e may be the actual source of the original data. Alternatively, the service provider may have contracted with the provisioning servers, or sources, 14a-e to store and/or keep records of the applications, and other data, provided by the service provider. In addition to providing data, these service providers may further be responsible for maintaining and updating the data and then storing the latest version of the data to the corresponding provisioning server 14a-e.

For example, a provisioning server 14a-e may be associated with a company that provides antivirus software. The provisioning server 14a-e would, therefore, provide whatever version of the antivirus software is most recent at that time to the user's electronic device 10, as well as constantly update the software it has stored with any new releases or versions. The provisioning server 14a-e may, therefore, store the most recent release or version of the antivirus software at any given time.

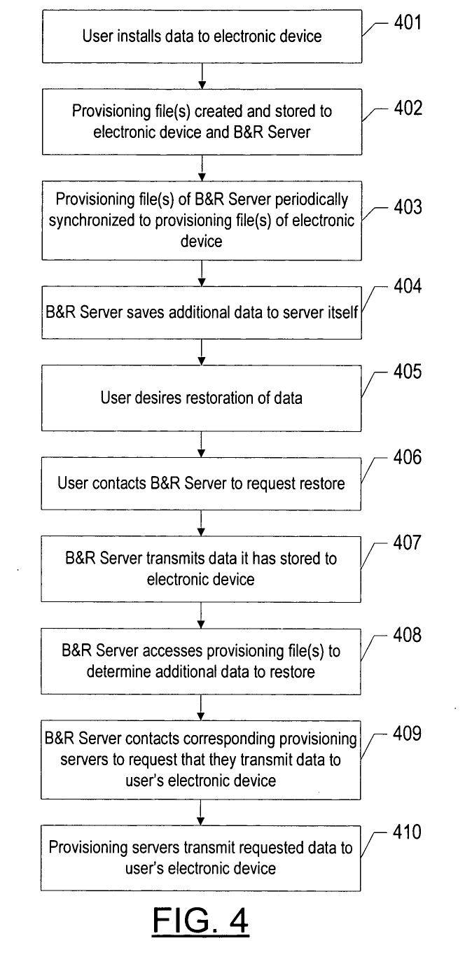

As is discussed in further detail below with respect to FIG. 4, according to one exemplary embodiment, the provisioning servers 14a-e are further used to distribute the responsibility for backup and restore services. In particular, rather than storing a backup copy of each application, or other data, provided by the provisioning servers 14a-e to the electronic device 10, 12 on a Traditional Backup System 18, the Backup and Restore Server 16, as well as the electronic device itself 10, 12, may maintain one or more provisioning files that describe that data (i.e., what it is and where and how it can be located and retrieved). In one exemplary embodiment, the provisioning file may describe the source of the data (i.e., an address associated with the provisioning server), the data itself (i.e., the name and version of the application or other data), where in the electronic device the provisioning file can be found (e.g., in what folder), when the application or other data was last updated, the size of the data, and the like.

In the event that the data installed on the electronic device 10, 12 is lost, the Backup and Restore Server 16 can access this file to determine which provisioning servers 14a-e to contact to request that they re-transmit the data previously installed on the electronic device 10, 12 and described in the provisioning file to the electronic device 10, 12. The amount of memory the backup and restore service provider is required to maintain is, therefore, much smaller, since the size of the provisioning files is much smaller than that of the actual data described.

In addition, however, certain situations may require that at least part of the actual data be backed up by the Backup and Restore Server 16. For this purpose the system may further include the Traditional Backup System 18. For example, the Backup and Restore Server 16 may upload from the electronic device 10, 12 data, such as emails or contact information, which was created by the electronic device 10, 12 using, for example, an application provided by a provisioning server 14a-e, and which the user desires to have backed up. In this instance, the Backup and Restore Server 16 may transmit the data to the Traditional Backup System 16 for storage. The amount of memory required is still less than if copies of all of the data stored on the electronic devices were being stored by the Traditional Backup System 16.

As shown, the system of exemplary embodiments may further include a Portal Server 20 though which the user can access his or her backup and restore service. In other words, the user can, though his or her electronic device 10, 12 view the provisioning file stored by the Backup and Restore Server 16, as well as the actual data stored by the Traditional Backup System 18. The user may also use the Portal Server 20 to transmit a request to the backup and restore service provider to begin a restoration process.

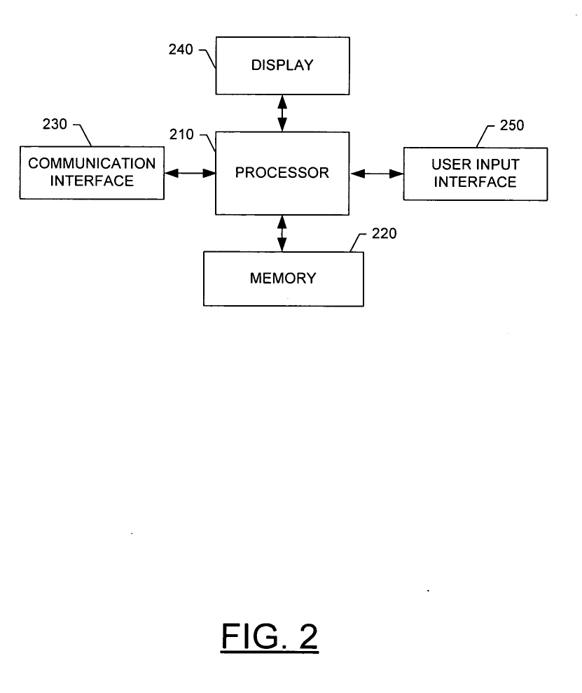

Referring now to FIG. 2, a block diagram of an entity capable of operating as a Backup and Restore server 16 and/or a provisioning server 14a-e is shown in accordance with one embodiment of the present invention. The entity capable of operating as a Backup and Restore and/or provisioning server includes various means for performing one or more functions in accordance with exemplary embodiments of the present invention, including those more particularly shown and described herein. It should be understood, however, that one or more of the entities may include alternative means for performing one or more like functions, without departing from the spirit and scope of the present invention. As shown, the entity capable of operating as a Backup and Restore server 16 and/or a provisioning server 14a-e can generally include means, such as a processor 210 connected to a memory 220, for performing or controlling the various functions of the entity. The memory can comprise volatile and/or non-volatile memory, and typically stores content, data or the like. For example, the memory typically stores content transmitted from, and/or received by, the entity. Also for example, the memory typically stores software applications, instructions or the like for the processor to perform steps associated with operation of the entity in accordance with embodiments of the present invention.

In addition to the memory 220, the processor 210 can also be connected to at least one interface or other means for displaying, transmitting and/or receiving data, content or the like. In this regard, the interface(s) can include at least one communication interface 230 or other means for transmitting and/or receiving data, content or the like, as well as at least one user interface that can include a display 240 and/or a user input interface 250. The user input interface, in turn, can comprise any of a number of devices allowing the entity to receive data from a user, such as a keypad, a touch display, a joystick or other input device.

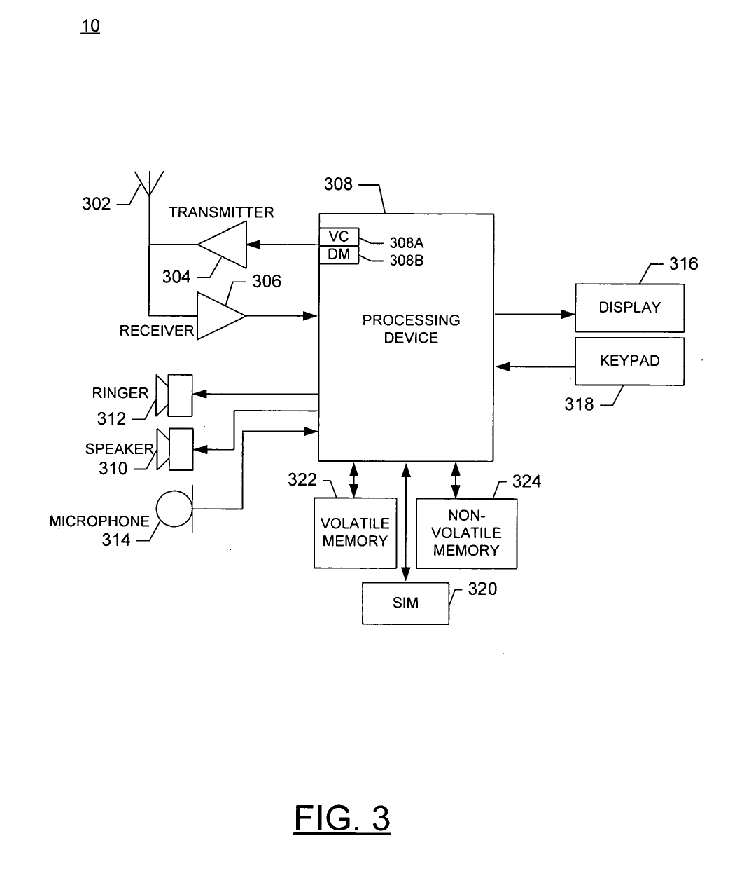

Reference is now made to FIG. 3, which illustrates one type of electronic device that would benefit from embodiments of the present invention. As shown, the electronic device may be a mobile station 10, and, in particular, a cellular telephone. It should be understood, however, that the mobile station illustrated and hereinafter described is merely illustrative of one type of electronic device that would benefit from the present invention and, therefore, should not be taken to limit the scope of the present invention. While several embodiments of the mobile station 10 are illustrated and will be hereinafter described for purposes of example, other types of mobile stations, such as personal digital assistants (PDAs), pagers, laptop computers, as well as other types of electronic systems including both mobile, wireless devices and fixed, wireline devices, can readily employ embodiments of the present invention.

The mobile station includes various means for performing one or more functions in accordance with exemplary embodiments of the present invention, including those more particularly shown and described herein. It should be understood, however, that one or more of the entities may include alternative means for performing one or more like functions, without departing from the spirit and scope of the present invention. More particularly, for example, as shown in FIG. 3, in addition to an antenna 302, the mobile station 10 includes a transmitter 304, a receiver 306, and means, such as a processing device 308, e.g., a processor, controller or the like, that provides signals to and receives signals from the transmitter 304 and receiver 306, respectively. These signals include signaling information in accordance with the air interface standard of the applicable cellular system and also user speech and/or user generated data. In this regard, the mobile station can be capable of operating with one or more air interface standards, communication protocols, modulation types, and access types. More particularly, the mobile station can be capable of operating in accordance with any of a number of second-generation (2G), 2.5G and/or third-generation (3G) communication protocols or the like. Further, for example, the mobile station can be capable of operating in accordance with any of a number of different wireless networking techniques, including Bluetooth, IEEE 802.11 WLAN (or Wi-Fi®), IEEE 802.16 WiMAX, ultra wideband (UWB), and the like.

It is understood that the processing device 308, such as a processor, controller or other computing device, includes the circuitry required for implementing the video, audio, and logic functions of the mobile station and is capable of executing application programs for implementing the functionality discussed herein. For example, the processing device may be comprised of various means including a digital signal processor device, a microprocessor device, and various analog to digital converters, digital to analog converters, and other support circuits. The control and signal processing functions of the mobile device are allocated between these devices according to their respective capabilities. The processing device 308 thus also includes the functionality to convolutionally encode and interleave message and data prior to modulation and transmission. The processing device can additionally include an internal voice coder (VC) 308A, and may include an internal data modem (DM) 308B. Further, the processing device 308 may include the functionality to operate one or more software applications, which may be stored in memory. For example, the controller may be capable of operating a connectivity program, such as a conventional Web browser. The connectivity program may then allow the mobile station to transmit and receive Web content, such as according to HTTP and/or the Wireless Application Protocol (WAP), for example.

The mobile station may also comprise means such as a user interface including, for example, a conventional earphone or speaker 310, a ringer 312, a microphone 314, a display 316, all of which are coupled to the controller 308. The user input interface, which allows the mobile device to receive data, can comprise any of a number of devices allowing the mobile device to receive data, such as a keypad 318, a touch display (not shown), a microphone 314, or other input device. In embodiments including a keypad, the keypad can include the conventional numeric (0-9) and related keys (#, *), and other keys used for operating the mobile station and may include a full set of alphanumeric keys or set of keys that may be activated to provide a full set of alphanumeric keys. Although not shown, the mobile station may include a battery, such as a vibrating battery pack, for powering the various circuits that are required to operate the mobile station, as well as optionally providing mechanical vibration as a detectable output.

The mobile station can also include means, such as memory including, for example, a subscriber identity module (SIM) 320, a removable user identity module (R-UIM) (not shown), or the like, which typically stores information elements related to a mobile subscriber. In addition to the SIM, the mobile device can include other memory. In this regard, the mobile station can include volatile memory 322, as well as other non-volatile memory 324, which can be embedded and/or may be removable. For example, the other non-volatile memory may be embedded or removable multimedia memory cards (MMCs), Memory Sticks as manufactured by Sony Corporation, EEPROM, flash memory, hard disk, or the like. The memory can store any of a number of pieces or amount of information and data used by the mobile device to implement the functions of the mobile station. For example, the memory can store an identifier, such as an international mobile equipment identification (IMEI) code, international mobile subscriber identification (IMSI) code, mobile device integrated services digital network (MSISDN) code, or the like, capable of uniquely identifying the mobile device. The memory can also store content. The memory may, for example, store computer program code for an application and other computer programs. For example, in one embodiment of the present invention, the memory may store computer program code for creating a provisioning file describing data installed on the electronic device (e.g., mobile station) 10 at the time the file is created, updating the file when additional data is installed, and synchronizing the provisioning file to a similar file stored on a network entity, such as the Backup and Restore Server 16, in order to ensure that the file stored on the Backup and Restore Server 16 is up to date. The memory may further store computer program code for transmitting information regarding the data currently installed on the mobile station to the Backup and Restore Server 16, so that the Backup and Restore Server 16 can create the aforementioned file. Alternatively, it may store code for transmitting the provisioning file itself.

The system, method, server, electronic device and computer program product of exemplary embodiments of the present invention are primarily described in conjunction with mobile communications applications. It should be understood, however, that the system, method, server, electronic device and computer program product of embodiments of the present invention can be utilized in conjunction with a variety of other applications, both in the mobile communications industries and outside of the mobile communications industries. For example, the system, method, mobile station and computer program product of exemplary embodiments of the present invention can be utilized in conjunction with wireline and/or wireless network (e.g., Internet) applications.

Method:

Reference is now made to FIG. 4, which provides a flow chart of the steps which may be taken in order to backup and restore data in accordance with exemplary embodiments of the present invention. As shown, the process begins at Step 401 where an electronic device (e.g., mobile phone) user installs a set of applications, settings and/or metadata to his or her phone. In addition, the user may order one or more services, having corresponding setup and application data, from a service provider. In one exemplary embodiment, the user is an employee of a company that has contracted with a particular backup and restore service provider for the provisioning of backup and restore services.

One or more provisioning files are then created, at Step 402, by either the electronic device itself or by the Backup and Restore Server associated with the backup and restore service provider. As discussed above, in one exemplary embodiment, the provisioning file stores information regarding the settings, applications, and/or metadata installed, and the services ordered in Step 401. In particular, the provisioning file describes the data installed (e.g., the name, size, version, date last updated, etc.), as well as where and how it can be located and retrieved (e.g., an address associated with the provisioning server responsible for providing the data to the electronic device for installation). The provisioning file does not include the actual data installed. Rather, it provides the information that would be needed to fetch and re-install the data where necessary. Exemplary embodiments of the present invention, therefore, alleviate the amount of memory required by the Backup and Restore Server, since the Backup and Restore Server need not store an actual copy of all of the data installed on the electronic device. Also in Step 402, a copy of the provisioning file(s) may be stored to both the electronic device (sometimes referred to as a “matching file”) and the Backup and Restore Server (sometimes referred to simply as a “file”).

Once the provisioning files (i.e., the “file” and the “matching file”) have been created and stored to the Backup and Restore Server and electronic device, respectively, the provisioning file(s) of the Backup and Restore server may be periodically updated and synchronized to the provisioning file(s) of the electronic device (i.e., the matching file), in Step 403. In particular, as additional data is installed on the device, the provisioning file located on the device, or matching file, is updated to incorporate a description of the newly installed data. As this point, then, the provisioning file of the Backup and Restore Server is no longer up to date. In order to ensure that the Backup and Restore Server has a record of the most recent installations and updates performed by the electronic device, therefore, the provisioning file of the Backup and Restore Server is periodically synchronized to the matching file (i.e., the provisioning device of the electronic device). This may be done, for example, according to standard or proprietary synchronization methods such as Open Mobile Alliance (OMA) Data Synchronization (DS) or Active Sync (see generally www.openmobilealliance.com/home).

In addition to the foregoing, as described above with reference to FIG. 1, it may be necessary for the Backup and Restore Server itself to store as backup data at least a portion of the data installed on or created by the electronic device in accordance with known methods (i.e., via the Traditional Backup System) (Step 404). For example, where a user creates data, which he or she wishes to back up, using an application installed on his or her electronic device, while the original application installed may be backed up in the manner described herein (i.e., using the provisioning file and one or more provisioning servers), the actual data created may conversely be stored by the Traditional Backup System. Similarly, one or more applications or other files may be considered most critical to the user of the electronic device with such critical applications and files being stored by the Backup and Restore Server and/or by a Traditional Backup System, thereby protecting the user of the electronic device from instances in which the original source of the critical applications or files no longer provides or supports the applications or files. In such a situation, the provisioning file could not only identify the Backup and Restore Server and/or the Traditional Backup System as the source of a backup copy, but could also identify the original source, such that in the event that the critical application or file would need to be restored, the Backup and Restore Server could first communicate with the original source to see if an updated or newer version of the application or file is available and, if so, restore the application or file with the updated or newer version of the application or file from the original source, but, if not, restore the application or file with the backup copy stored by the Backup and Restore Server and/or by a Traditional Backup System.

At some point, the user may desire to restore data to his or her electronic device (Step 405). For example, the user's phone, or other electronic device, may be attacked by a software virus or otherwise lose all or part of the data previously installed on the phone. Alternatively, the user may merely wish to return his or her device to a previous state prior to, for example, the installation of a harmful application. In one exemplary embodiment, the restoration may occur automatically when the device recognizes that a harmful application has been installed and that restoration to a previous state is needed. In another instance, the user may have lost his or her phone and wish to have the data originally saved on his or her phone installed on a new electronic device.

In order to restore the data, to either the existing or new electronic device, in Step 406, the user may contact the Backup and Restore server in order to initiate the restore process. In one exemplary embodiment, this is done by using an alternative electronic device (e.g., a laptop or other device associated with the user) to access a Portal Server associated with the Backup and Restore service provider. Through the Portal Server the user can access and view the data stored by the backup and restore service and the provisioning file, as well as request that the data lost be restored.

In response, in Step 407, the Backup and Restore server may first determine what data it has stored via the Traditional Backup System and transmit that data to the electronic device. The Backup and Restore Server may then, in Step 408, access the one or more provisioning files corresponding with the user's device that the Backup and Restore Server has stored to determine what additional data needs to be located and restored. The Backup and Restore Server will use the accessed file to determine the location of that data in the various provisioning servers. In particular, the provisioning file may include an address for the provisioning server from which the electronic device originally received and installed the data.

Once the Backup and Restore Server has determined the location of one or more provisioning servers responsible for initially providing the data described in the provisioning file and of storing that data (and, in one exemplary embodiment, the latest version of that data), the Backup and Restore server will, in Step 409, contact the corresponding provisioning servers and request that they transmit the lost data to the user's device. In one exemplary embodiment, the user may specify, for example in the contract reached between the user and the backup and restore service provider, that he or she wants to receive the latest version or release of the data lost. Alternatively, the user may indicate that he or she wishes to receive the last version or release he or she had installed. In addition, in the situation where the user's electronic device has been attacked by a virus, the user may request that the data be re-installed to that same device. Alternatively, in the situation where the user has lost his or her electronic device, he or she may request that the data be installed on the new electronic device.

Finally, in Step 410, the provisioning servers contacted by the Backup and Restore Server will install the lost data to the phone, or other device, using, for example, the OMA DS or OMA Device Management (DM) methods. In one exemplary embodiment, this installation can be performed over a local connection in order to save time and money.

Conclusion:

As described above and as will be appreciated by one skilled in the art, embodiments of the present invention may be configured as a system, method, network entity or electronic device. Accordingly, embodiments of the present invention may be comprised of various means including entirely of hardware, entirely of software, or any combination of software and hardware. Furthermore, embodiments of the present invention may take the form of a computer program product on a computer-readable storage medium having computer-readable program instructions (e.g., computer software) embodied in the storage medium. Any suitable computer-readable storage medium may be utilized including hard disks, CD-ROMs, optical storage devices, or magnetic storage devices.

Exemplary embodiments of the present invention have been described above with reference to block diagrams and flowchart illustrations of methods, apparatuses (i.e., systems) and computer program products. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method of restoring data comprising:
receiving a request to restore data installed on an electronic device associated with a user;
accessing a file comprising a description of the data installed on the electronic device;
locating, based on the description, one or more sources of the data; and
transmitting a signal to at least one source, said signal requesting transmission of the data described in the file.

2. The method of claim 1, wherein the description comprises at least one of a name, location or version associated with the data.

3. The method of claim 1 further comprising:
storing the file.

4. The method of claim 3, wherein a matching file also comprising a description of the data installed on the electronic device is stored on the electronic device, said matching file capable of being updated when additional data is installed on the electronic device.

5. The method of claim 4 further comprising:
synchronizing the file to the matching file, such that the file comprises an up to date description of the data following synchronization.

6. The method of claim 1 further comprising:
creating the file based on information received from the electronic device regarding data installed on the electronic device;
storing the file;
creating a matching file also comprising a description of the data installed on the electronic device;
transmitting the matching file to the electronic device; and
periodically synchronizing the file to the matching file, wherein the matching file is capable of being updated when additional data is installed on the electronic device, such that the file comprises an up to date description of installed data following synchronization.

7. The method of claim 1, wherein the sources are associated with one or more service providers responsible for providing the data to the electronic device for installation.

8. The method of claim 7, wherein the sources are further responsible for updating the data and storing a latest version of the data.

9. The method of claim 8, wherein transmitting a signal comprises transmitting a signal requesting transmission of the latest version of the data.

10. The method of claim 1, wherein transmitting a signal comprises transmitting a signal requesting transmission of the data to the electronic device.

11. The method of claim 1, wherein transmitting a signal comprises transmitting a signal requesting transmission of the data to a second electronic device associated with the user.

12. A system for backing up and restoring data comprising:
an electronic device associated with a user, said device capable of storing data;
one or more provisioning servers capable of providing the data to the electronic device for installation; and
a backup and restore server capable of accessing a file comprising a description of the data installed on the electronic device to determine a location associated with at least one provisioning server responsible for providing the data described in the file and transmitting a signal to the at least one provisioning server, said signal requesting transmission of the data.

13. The system of claim 12, wherein the description comprises at least one of a name or version associated with the data and an address corresponding to the at least one provisioning server.

14. The system of claim 12, wherein the electronic device is further capable of storing a matching file also comprising a description of the data installed on the electronic device, and of updating the matching file as additional data is installed, such that the description contained in the matching file differs from the description contained in the file following installation of additional data.

15. The system of claim 14, wherein the backup and restore server is further capable of periodically synchronizing the file to the matching file, such that the file comprises an up to date description of the data installed on the electronic device following synchronization.

16. The system of claim 12, wherein the backup and restore server is further capable of creating the file.

17. The system of claim 12, wherein the electronic device is further capable of creating the file.

18. The system of claim 12, wherein the one or more provisioning servers are responsible for updating the data and storing a latest version of the data to respective servers.

19. The system of claim 12, wherein the backup and restore server is further capable of transmitting a signal to the at least one provisioning server requesting transmission of the data to the electronic device.

20. The system of claim 12, further comprising a second electronic device associated with the user, wherein the backup and restore server is capable of restoring the data to the second electronic device associated with the user by transmitting a signal to the at least one provisioning server, said signal requesting transmission of the data to the second electronic device.

21. A network entity comprising:
a processor; and
a memory in communication with the processor that stores an application executable by the processor, wherein the application is capable, upon execution, of:
receiving a request to restore data installed on an electronic device associated with a user;
accessing a file comprising a description of the data installed on the electronic device;
locating, based on the description, one or more provisioning sources responsible for storing the data, said provisioning sources associated with one or more original sources of the data; and
transmitting a signal to at least one of the provisioning sources, said signal requesting transmission of the data described in the file.

22. The network entity of claim 21, wherein the description comprises at least one of a name or version associated with the data and a location of the at least one provisioning source.

23. The network entity of claim 21, wherein the application is further capable, upon execution, of synchronizing the file to a matching file stored on the electronic device, said matching file also containing a description of the data installed on the electronic device, wherein the matching file is capable of being updated when additional data is installed on the electronic device, such that the description contained in the matching file differs from the description contained in the file following installation of additional data, and further that the file comprises an up to date description of the data installed following synchronization to the matching file.

24. The network entity of claim 21, wherein the provisioning sources are further responsible for updating the data and storing a latest version of the data to respective provisioning sources.

25. An electronic device for backing up and restoring data comprising:
a processor; and
a memory in communication with the processor that stores an application executable by the processor, said application capable, upon execution, of creating a first provisioning file comprising a description of data installed on the electronic device, updating the first provisioning file as additional data is installed on the device, and synchronizing the first provisioning file to a second provisioning file stored on a network entity, such that the network entity is capable of using the second provisioning file to provide the data to the electronic device.

26. The device of claim 25, wherein the application is further capable, upon execution of transmitting a signal requesting transmission of the latest version of the data.

27. The device of claim 25, wherein the application is further capable, upon execution, of transmitting information regarding data initially installed on the electronic device to the network entity for use in creating the second provisioning file.

28. A computer program product for restoring data, wherein the computer program product comprises at least one computer-readable storage medium having computer-readable program code portions stored therein, the computer-readable program portions comprising:
a first executable portion for receiving a request to restore data installed on an electronic device associated with a user;
a second executable portion for accessing a file comprising a description of the data installed on the electronic device;
a third executable portion for locating, based on the description, one or more sources responsible for storing the data; and
a fourth executable portion for transmitting a signal to the sources, said signal requesting transmission of the data described in the file.

29. The computer program product of claim 28, wherein the description comprises at least one of a name, location or version associated with the data.

30. The computer program product of claim 28, wherein a matching file also comprising a description of the data installed on the electronic device is stored on the electronic device, said matching file capable of being updated when additional data is installed on the electronic device.

31. The computer program product of claim 30 further comprising:
a fifth executable portion for synchronizing the file to the matching file, such that the file comprises an up to date description of the data following synchronization.

32. The computer program product of claim 28 further comprising:
a fifth executable portion for creating the file based on information received from the electronic device regarding data originally installed on the electronic device;
a sixth executable portion for storing the file;
a seventh executable portion for creating a matching file also comprising a description of the data originally installed on the electronic device;
an eighth executable portion for transmitting the matching file to the electronic device; and
a ninth executable portion for periodically synchronizing the file to the matching file, wherein the matching file is capable of being updated when additional data is installed on the electronic device, such that the file comprises an up to date description of installed data following synchronization.

33. The computer program product of claim 28, wherein the sources are associated with one or more service providers responsible for providing the data to the electronic device for installation.

34. The computer program product of claim 28, wherein the fourth executable portion is capable of transmitting a signal requesting transmission of the data to the electronic device.
